(19) United States
(12) Patent Application Publication
(10) Pub. No.: US 2022/0143588 A1
(43) Pub. Date: May 12, 2022

(54) CATALYST SYSTEM AND PROCESS USING SSZ-91 AND SSZ-95

(71) Applicant: CHEVRON U.S.A. INC., San Ramon, CA (US)

(72) Inventors: Yihua ZHANG, Albany, CA (US); Guan-Dao LEI, Walnut Creek, CA (US)

(21) Appl. No.: 17/095,337

(22) Filed: Nov. 11, 2020

(51) Int. Cl. B01J 29/74; C10G 45/64; C10G 47/20; C10G 25/03

(52) U.S. Cl. CPC B01J 29/7446; C10G 45/64; B01J 29/7461; B01J 29/7492; C10G 2300/304; C10G 25/03; C10G 2300/70; C10G 2300/302; C10G 47/20

(57) ABSTRACT

An improved hydroisomerization catalyst system and process for making a base oil product using a combined catalyst system comprising SSZ-91 molecular sieve and SSZ-95 molecular sieve. The catalyst system and process generally involves the use of a catalyst comprising an SSZ-91 molecular sieve and a separate catalyst comprising an SSZ-95 molecular sieve to produce dewaxed base oil products by sequentially contacting the catalysts with a hydrocarbon feedstock. The catalyst system and process provide improved base oil yield along with other beneficial base oil properties.

### FIELD OF THE INVENTION

A hydroisomerization catalyst system and process for producing base oils from hydrocarbon feedstocks using catalysts comprising SSZ-91 molecular sieve and SSZ-95 molecular sieve.

### BACKGROUND OF THE INVENTION

A hydroisomerization catalytic dewaxing process for the production of base oils from a hydrocarbon feedstock involves introducing the feed into a reactor containing a dewaxing catalyst system with the presence of hydrogen. Within the reactor, the feed contacts the hydroisomerization catalyst under hydroisomerization dewaxing conditions to provide an isomerized stream.

Hydroisomerization removes aromatics and residual nitrogen and sulfur and isomerize the normal paraffins to improve the cold flow properties. The isomerized stream may be further contacted in a second reactor with a hydrofinishing catalyst to remove traces of any aromatics, olefins, improve color, and the like from the base oil product. The hydrofinishing unit may include a hydrofinishing catalyst comprising an alumina support and a noble metal, typically palladium, or platinum in combination with palladium.

The challenges generally faced in typical hydroisomerization catalytic dewaxing processes include, among others, providing product(s) that meet pertinent product specifications, such as cloud point, pour point, viscosity and/or viscosity index limits for one or more products, while also maintaining good product yield. In addition, further upgrading, e.g., during hydrofinishing, to further improve product quality may be used, e.g., for color and oxidation stability by saturating aromatics to reduce the aromatics content. The presence of residual organic sulfur and nitrogen from upstream hydrotreatment and hydrocracking processes, however, may have a significant impact on downstream processes and final base oil product quality.

Dewaxing of straight chain paraffins involves a number of hydroconversion reactions, including hydroisomerization, redistribution of branches, and secondary hydroisomerization. Consecutive hydroisomerization reactions lead to an increased degree of branching accompanied by a redistribution of branches. Increased branching generally increases the probability of chain cracking, leading to greater fuels yield and a loss of base oil/lube yield. Minimizing such reactions, including the formation of hydroisomerization transition species, can therefore lead to increased base oil/lube yield.

A more robust catalyst system for base oil/lube production is therefore needed to isomerize wax molecules and provide increased base oil/lube yield by reducing undesired cracking and hydroisomerization reactions. Accordingly, a continuing need exists for catalysts, catalyst systems, and processes to produce base oil/lube products, while also providing good base oil/lube product yield.

### SUMMARY OF THE INVENTION

This invention relates to a hydroisomerization catalyst system and process for converting wax-containing hydrocarbon feedstocks into high-grade products, including base or lube oils generally having an increased yield of base oil product. The catalyst system and processes employ a catalyst system comprising a first catalyst composition comprising an SSZ-91 molecular sieve and a second catalyst composition comprising an SSZ-95 molecular sieve. The first catalyst and the second catalyst compositions are arranged such that a hydrocarbon feedstock may be sequentially contacted with either the first or the second catalyst composition to provide a first stage product followed by contacting the first stage product with the other catalyst composition to provide a second stage product. The hydroisomerization process converts aliphatic, unbranched paraffinic hydrocarbons (n-paraffins) to isoparaffins and cyclic species, thereby decreasing the pour point and cloud point of the base oil product as compared with the feedstock. Catalyst systems formed from the combination of SSZ-91 and SSZ-95 have been found to advantageously provide base oil products having an increased base oil/lube product yield as compared with base oil products produced using SSZ-91 catalysts or SSZ-95 catalysts by themselves.

In one aspect, the present invention is directed to a hydroisomerization catalyst system and process, which are useful to make dewaxed products including base oils, particularly base oil products of one or more product grades through hydroprocessing of a suitable hydrocarbon feedstream. While not necessarily limited thereto, one of the goals of the invention is to provide increased base oil product yield while also providing other beneficial base oil product characteristics.

The first catalyst composition generally comprises an SSZ-91 molecular sieve and the second catalyst composition generally comprises an SSZ-95 molecular sieve. Each catalyst composition may also comprise a matrix material and at least one modifier selected from Groups 6 to 10 and Group 14 of the Periodic Table. The modifier may further comprise a Group 2 metal of the Periodic Table.

The hydroisomerization process generally comprises contacting a hydrocarbon feedstock with the hydroisomerization catalyst system under hydroisomerization conditions to produce a base oil product or product stream. The feedstock may be first contacted with either the first or the second catalyst composition to provide a first stage product followed by contacting the first stage product with the other catalyst composition (i.e., the corresponding second or first catalyst composition) to provide a second stage product. The second stage product may itself be a base oil product, or may be used to make a base oil product. For example, in some embodiments, the process may provide a base oil product having a viscosity index of at least about 109 and/or a pour point of no greater than about −10° C. or −13° C.

### DETAILED DESCRIPTION

Although illustrative embodiments of one or more aspects are provided herein, the disclosed processes may be implemented using any number of techniques. The disclosure is not limited to the illustrative or specific embodiments, drawings, and techniques illustrated herein, including any exemplary designs and embodiments illustrated and described herein, and may be modified within the scope of the appended claims along with their full scope of equivalents.

Unless otherwise indicated, the following terms, terminology, and definitions are applicable to this disclosure. If a term is used in this disclosure but is not specifically defined herein, the definition from the IUPAC Compendium of Chemical Terminology, 2nd ed (1997), may be applied, provided that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein is to be understood to apply.

“API gravity” refers to the gravity of a petroleum feedstock or product relative to water, as determined by ASTM D4052-11.

“Viscosity index” (VI) represents the temperature dependency of a lubricant, as determined by ASTM D2270-10(E2011).

“Vacuum gas oil” (VGO) is a byproduct of crude oil vacuum distillation that can be sent to a hydroprocessing unit or to an aromatic extraction for upgrading into base oils. VGO generally comprises hydrocarbons with a boiling range distribution between 343° C. (649° F.) and 593° C. (1100° F.) at 0.101 MPa.

“Treatment,” “treated,” “upgrade,” “upgrading” and “upgraded,” when used in conjunction with an oil feedstock, describes a feedstock that is being or has been subjected to hydroprocessing, or a resulting material or crude product, having a reduction in the molecular weight of the feedstock, a reduction in the boiling point range of the feedstock, a reduction in the concentration of asphaltenes, a reduction in the concentration of hydrocarbon free radicals, and/or a reduction in the quantity of impurities, such as sulfur, nitrogen, oxygen, halides, and metals.

“Hydroprocessing” refers to a process in which a carbonaceous feedstock is brought into contact with hydrogen and a catalyst, at a higher temperature and pressure, for the purpose of removing undesirable impurities and/or converting the feedstock to a desired product. Examples of hydroprocessing processes include hydrocracking, hydrotreating, catalytic dewaxing, and hydrofinishing.

“Hydrocracking” refers to a process in which hydrogenation and dehydrogenation accompanies the cracking/fragmentation of hydrocarbons, e.g., converting heavier hydrocarbons into lighter hydrocarbons, or converting aromatics and/or cycloparaffins (naphthenes) into non-cyclic branched paraffins.

“Hydrotreating” refers to a process that converts sulfur and/or nitrogen-containing hydrocarbon feeds into hydrocarbon products with reduced sulfur and/or nitrogen content, typically in conjunction with hydrocracking, and which generates hydrogen sulfide and/or ammonia (respectively) as byproducts. Such processes or steps performed in the presence of hydrogen include hydrodesulfurization, hydrodenitrogenation, hydrodemetallation, and/or hydrodearomatization of components (e.g., impurities) of a hydrocarbon feedstock, and/or for the hydrogenation of unsaturated compounds in the feedstock. Depending on the type of hydrotreating and the reaction conditions, products of hydrotreating processes may have improved viscosities, viscosity indices, saturates content, low temperature properties, volatilities and depolarization, for example. The terms “guard layer” and “guard bed” may be used herein synonymously and interchangeably to refer to a hydrotreating catalyst or hydrotreating catalyst layer. The guard layer may be a component of a catalyst system for hydrocarbon dewaxing, and may be disposed upstream from at least one hydroisomerization catalyst.

“Catalytic dewaxing”, or hydroisomerization, refers to a process in which normal paraffins are isomerized to their more branched counterparts by contact with a catalyst in the presence of hydrogen.

“Hydrofinishing” refers to a process that is intended to improve the oxidation stability, UV stability, and appearance of the hydrofinished product by removing traces of aromatics, olefins, color bodies, and solvents. UV stability refers to the stability of the hydrocarbon being tested when exposed to UV light and oxygen. Instability is indicated when a visible precipitate forms, usually seen as Hoc or cloudiness, or a darker color develops upon exposure to ultraviolet light and air. A general description of hydrofinishing may be found in U.S. Pat. Nos. 3,852,207 and 4,673,487.

The term “Hydrogen” or “hydrogen” refers to hydrogen itself, and/or a compound or compounds that provide a source of hydrogen.

“Cut point” refers to the temperature on a True Boiling Point (TBP) curve at which a predetermined degree of separation is reached.

“Pour point” refers to the temperature at which an oil will begin to flow under controlled conditions. The pour point may be determined by, for example, ASTM D5950.

“Cloud point” refers to the temperature at which a lube base oil sample begins to develop a haze as the oil is cooled under specified conditions. The cloud point of a lube base oil is complementary to its pour point. Cloud point may be determined by, for example, ASTM D5773.

“TBP” refers to the boiling point of a hydrocarbonaceous feed or product, as determined by Simulated Distillation (SimDist) by ASTM D2887-13.

“Hydrocarbonaceous”, “hydrocarbon” and similar terms refer to a compound containing only carbon and hydrogen atoms. Other identifiers may be used to indicate the presence of particular groups, if any, in the hydrocarbon (e.g., halogenated hydrocarbon indicates the presence of one or more halogen atoms replacing an equivalent number of hydrogen atoms in the hydrocarbon).

The term “Periodic Table” refers to the version of the IUPAC Periodic Table of the Elements dated Jun. 22, 2007, and the numbering scheme for the Periodic Table Groups is as described in Chem. Eng. News, 63(5), 26-27 (1985). “Group 2” refers to IUPAC Group 2 elements, e.g., magnesium, (Mg), Calcium (Ca), Strontium (Sr), Barium (Ba) and combinations thereof in any of their elemental, compound, or ionic form. “Group 6” refers to IUPAC Group 6 elements, e.g., chromium (Cr), molybdenum (Mo), and tungsten (W). “Group 7” refers to IUPAC Group 7 elements, e.g., manganese (Mn), rhenium (Re) and combinations thereof in any of their elemental, compound, or ionic form. “Group 8” refers to IUPAC Group 8 elements, e.g., iron (Fe), ruthenium (Ru), osmium (Os) and combinations thereof in any of their elemental, compound, or ionic form. “Group 9” refers to IUPAC Group 9 elements, e.g., cobalt (Co), rhodium (Rh), iridium (Ir) and combinations thereof in any of their elemental, compound, or ionic form. “Group 10” refers to IUPAC Group 10 elements, e.g., nickel (Ni), palladium (Pd), platinum (Pt) and combinations thereof in any of their elemental, compound, or ionic form. “Group 14” refers to IUPAC Group 14 elements, e.g., germanium (Ge), tin (Sn), lead (Pb) and combinations thereof in any of their elemental, compound, or ionic form.

The term “support”, particularly as used in the term “catalyst support”, refers to conventional materials that are typically a solid with a high surface area, to which catalyst materials are affixed. Support materials may be inert or participate in the catalytic reactions, and may be porous or non-porous. Typical catalyst supports include various kinds of carbon, alumina, silica, and silica-alumina, e.g., amorphous silica aluminates, zeolites, alumina-boria, silica-alumina-magnesia, silica-alumina-titania and materials obtained by adding other zeolites and other complex oxides thereto.

“Molecular sieve” refers to a material having uniform pores of molecular dimensions within a framework structure, such that only certain molecules, depending on the type of molecular sieve, have access to the pore structure of the molecular sieve, while other molecules are excluded, e.g., due to molecular size and/or reactivity. The term “molecular sieve” and “zeolite” are synonymous and include (a) intermediate and (b) final or target molecular sieves and molecular sieves produced by (1) direct synthesis or (2) post-crystallization treatment (secondary modification). Secondary synthesis techniques allow for the synthesis of a target material from an intermediate material by heteroatom lattice substitution or other techniques. For example, an aluminosilicate can be synthesized from an intermediate borosilicate by post-crystallization heteroatom lattice substitution of the Al for B. Such techniques are known, for example as described in U.S. Pat. No. 6,790,433. Zeolites, crystalline aluminophosphates and crystalline silicoaluminophosphates are representative examples of molecular sieves.

In this disclosure, while compositions and methods or processes are often described in terms of “comprising” various components or steps, the compositions and methods may also “consist essentially of” or “consist of” the various components or steps, unless stated otherwise.

The terms “a,” “an,” and “the” are intended to include plural alternatives, e.g., at least one. For instance, the disclosure of “a transition metal” or “an alkali metal” is meant to encompass one, or mixtures or combinations of more than one, transition metal or alkali metal, unless otherwise specified.

All numerical values within the detailed description and the claims herein are modified by “about” or “approximately” the indicated value, and take into account experimental error and variations that would be expected by a person having ordinary skill in the art.

In one aspect, the present invention is a hydroisomerization catalyst system, useful to make dewaxed products including base/lube oils, the catalyst system comprising a first catalyst composition comprising an SSZ-91 molecular sieve and a second catalyst composition comprising an SSZ-95 molecular sieve. The first catalyst and the second catalyst compositions are arranged such that a hydrocarbon feedstock may be sequentially contacted with either the first or the second catalyst composition to provide a first stage product followed by contacting the first stage product with the other catalyst composition to provide a second stage product. The first catalyst composition generally comprises an SSZ-91 molecular sieve and the second catalyst composition generally comprises an SSZ-95 molecular sieve. Each catalyst composition may also comprise a matrix material and at least one modifier selected from Groups 6 to 10 and Group 14 of the Periodic Table. The modifier may further comprise a Group 2 metal of the Periodic Table.

In a further aspect, the present invention concerns a hydroisomerization process, useful to make dewaxed products including base oils, the process comprising contacting a hydrocarbon feedstock with the hydroisomerization catalyst system under hydroisomerization conditions to produce a base oil product or product stream. The feedstock may be first contacted with either the first or the second catalyst composition to provide a first stage product followed by contacting the first stage product with the other catalyst composition (i.e., the corresponding second or first catalyst composition) to provide a second stage product. The second stage product may itself be a base oil product, or may be used to make a base oil product.

The SSZ-91 molecular sieve used in the hydroisomerization catalyst system and process is described in, e.g., U.S. Pat. Nos. 9,802,830; 9,920,260; 10,618,816; and in WO2017/034823. The SSZ-91 molecular sieve generally comprises ZSM-48 type zeolite material, the molecular sieve having at least 70% polytype 6 of the total ZSM-48-type material; an EUO-type phase in an amount of between 0 and 3.5 percent by weight; and polycrystalline aggregate morphology comprising crystallites having an average aspect ratio of between 1 and 8. The silicon oxide to aluminum oxide mole ratio of the SSZ-91 molecular sieve may be in the range of 40 to 220 or 50 to 220 or 40 to 200. In some cases, the SSZ-91 molecular sieve may have at least 70% polytype 6 of the total ZSM-48-type material; an EUO-type phase in an amount of between 0 and 3.5 percent by weight; and polycrystalline aggregate morphology comprising crystallites having an average aspect ratio of between 1 and 8. In some cases, the SSZ-91 material is composed of at least 90% polytype 6 of the total ZSM-48-type material present in the product. The polytype 6 structure has been given the framework code *MRE by the Structure Commission of the International Zeolite Association. The term “*MRE-type molecular sieve” and “EUO-type molecular sieve” includes all molecular sieves and their isotypes that have been assigned the International Zeolite Association framework, as described in the Atlas of Zeolite Framework Types, eds. Ch. Baerlocher, L. B. Mccusker and D. H. Olson, Elsevier, 6th revised edition, 2007 and the Database of Zeolite Structures on the International Zeolite Association's website (http://www.iza-online.org).

The foregoing noted patents provide additional details concerning SSZ-91 molecular sieves, methods for their preparation, and catalysts formed therefrom.

The SSZ-95 molecular sieve used in the hydroisomerization catalyst system and process is described in, e.g., U.S. Pat. Nos. 9,573,124; 10,052,619; 10,272,422; and in WO2015/179228. The SSZ-95 molecular sieve is generally an MTT framework molecular sieve having a mole ratio of 20 to 70 of silicon oxide to aluminum oxide, a total micropore volume of between 0.005 and 0.02 cc/g; and a H-D exchangeable acid site density of up to 50% relative to SSZ-32.

The molecular sieve of each of the first and second catalyst compositions is generally combined with a matrix material to form, respectively, a first and second base material. The base material may, e.g., be formed as a base extrudate by combining the sieve with the matrix material, extruding the mixture to form shaped extrudates, followed by drying and calcining of the extrudate. Each of the first and second catalyst compositions also typically further comprises at least one modifier selected from Groups 6 to 10 and Group 14, and optionally further comprising a Group 2 metal, of the Periodic Table. Modifiers may be added through the use of impregnation solutions comprising modifier compounds.

Suitable matrix materials for either or both of the first and second catalyst compositions include alumina, silica, ceria, titania, tungsten oxide, zirconia, or a combination thereof. In some embodiments, aluminas for the first and/or second catalyst compositions and the process may also be a “high nanopore volume” alumina, abbreviated as “HNPV” alumina, as described in U.S. application Ser. No. 17/095,010 (docket no. T-11311), filed on Nov. 11, 2020, herein incorporated by reference. Suitable aluminas are commercially available, including, e.g., Catapal® aluminas and Pural® aluminas from Sasol or Versal® aluminas from UOP.

Suitable modifiers are selected from Groups 6-10 and Group 14 of the Periodic Table (IUPAC). Suitable Group 6 modifiers include Group 6 elements, e.g., chromium (Cr), molybdenum (Mo), and tungsten (W) and combinations thereof in any of their elemental, compound, or ionic form. Suitable Group 7 modifiers include Group 7 elements, e.g., manganese (Mn), rhenium (Re) and combinations thereof in any of their elemental, compound, or ionic form. Suitable Group 8 modifiers include Group 8 elements, e.g., iron (Fe), ruthenium (Ru), osmium (Os) and combinations thereof in any of their elemental, compound, or ionic form. Suitable Group 9 modifiers include Group 9 elements, e.g., cobalt (Co), rhodium (Rh), iridium (Ir) and combinations thereof in any of their elemental, compound, or ionic form. Suitable Group 10 modifiers include Group 10 elements, e.g., nickel (Ni), palladium (Pd), platinum (Pt) and combinations thereof in any of their elemental, compound, or ionic form. Suitable Group 14 modifiers include Group 14 elements, e.g., germanium (Ge), tin (Sn), lead (Pb) and combinations thereof in any of their elemental, compound, or ionic form. In addition, optional Group 2 modifiers may be present, including Group 2 elements, e.g., magnesium, (Mg), Calcium (Ca), Strontium (Sr), Barium (Ba) and combinations thereof in any of their elemental, compound, or ionic form.

The modifier advantageously comprises one or more Group 10 metals. The Group 10 metal may be, e.g., platinum, palladium or a combination thereof. Platinum is a suitable Group 10 metal along with another Groups 6 to 10 and Group 14 metal in some aspects. While not limited thereto, the Groups 6 to 10 and Group 14 metal may be more narrowly selected from Pt, Pd, Ni, Re, Ru, Ir, Sn, or a combination thereof. In conjunction with Pt as a first metal in the first and/or second catalyst compositions, an optional second metal in the first and/or second catalyst compositions may also be more narrowly selected from the Groups 6 to 10 and Group 14 metals, such as, e.g., Pd, Ni, Re, Ru, Ir, Sn, or a combination thereof. In a more specific instance, the catalyst may comprise Pt as a Group 10 metal in an amount of 0.01-5.0 wt. % or 0.01-2.0 wt. %, or 0.1-2.0 wt. %, more particularly 0.01-1.0 wt. % or 0.3-0.8 wt. %. An optional second metal selected from Pd, Ni, Re, Ru, Ir, Sn, or a combination thereof as a Group 6 to 10 and Group 14 metal may be present, in an amount of 0.01-5.0 wt. % or 0.01-2.0 wt. %, or 0.1-2.0 wt. %, more particularly 0.01-1.0 wt. % and 0.01-1.5 wt. %.

The metals content in the first and second catalyst compositions may be varied over useful ranges, e.g., the total modifying metals content for the catalyst may be 0.01-5.0 wt. % or 0.01-2.0 wt. %, or 0.1-2.0 wt. % (total catalyst weight basis). In some instances, the catalyst compositions comprise 0.1-2.0 wt. % Pt as one of the modifying metals and 0.01-1.5 wt. % of a second metal selected from Groups 6 to 10 and Group 14, or 0.3-1.0 wt. % Pt and 0.03-1.0 wt. % second metal, or 0.3-1.0 wt. % Pt and 0.03-0.8 wt. % second metal. In some cases, the ratio of the first Group 10 metal to the optional second metal selected from Groups 6 to 10 and Group 14 may be in the range of 5:1 to 1:5, or 3:1 to 1:3, or 1:1 to 1:2, or 5:1 to 2:1, or 5:1 to 3:1, or 1:1 to 1:3, or 1:1 to 1:4. In more specific cases, the first and/or second catalyst compositions comprise 0.01 to 5.0 wt. % of the modifying metal, 1 to 99 wt. % of the matrix material, and 0.1 to 99 wt. % of the SSZ-91 or SSZ-95 molecular sieve.

The base extrudate may be made according to any suitable method. For example, the base extrudates for the first and/or second catalyst compositions may be conveniently made by mixing the components together and extruding the well mixed SSZ-91/matrix material and/or SSZ-95/matrix material mixtures to form the base extrudates. The extrudates are next dried and calcined, followed by loading of any modifiers onto the base extrudates. Suitable impregnation techniques may be used to disperse the modifiers onto the base extrudate. The method of making the base extrudate is not intended to be particularly limited according to specific process conditions or techniques, however.

The hydrocarbon feed may generally be selected from a variety of base oil feedstocks, and advantageously comprises gas oil; vacuum gas oil; long residue; vacuum residue; atmospheric distillate; heavy fuel; oil; wax and paraffin; used oil; deasphalted residue or crude; charges resulting from thermal or catalytic conversion processes; shale oil; cycle oil; animal and vegetable derived fats, oils and waxes; petroleum and slack wax; or a combination thereof. The hydrocarbon feed may also comprise a feed hydrocarbon cut in the distillation range from 400-1300° F., or 500-1100° F., or 600-1050° F., and/or wherein the hydrocarbon feed has a KV100 (kinematic viscosity at 100° C.) range from about 3 to 30 cSt or about 3.5 to 15 cSt.

In some cases, the process may be used advantageously for a light or heavy neutral base oil feedstock, such as a vacuum gas oil (VGO), as the hydrocarbon feed where the SSZ-91 and SSZ-95 catalyst compositions include a Pt modifying metal, or a combination of Pt with another modifier.

The product(s), or product streams, may be used to produce one or more base oil products, e.g., to produce multiple grades having a KV100 in the range of about 2 to 30 cSt. Such base oil products may, in some cases, have a pour point of not more than about −10° C., or −13° C.

The process and catalyst system may also be combined with additional process steps, or system components, e.g., the feedstock may be further subjected to hydrotreating conditions with a hydrotreating catalyst prior to contacting the hydrocarbon feedstock with the SSZ-91 catalyst composition or the SSZ-95 catalyst composition, optionally, wherein the hydrotreating catalyst comprises a guard layer catalyst comprising a refractory inorganic oxide material containing about 0.1 to 1 wt. % Pt and about 0.2 to 1.5 wt. % Pd.

Among the advantages provided by the present process and catalyst system, are the improvement in yield of base oil product produced using the combination of the first and second catalyst compositions based on SSZ-91 and SSZ-95 molecular sieves, as compared with the same process wherein only an SSZ-91 catalyst composition or only an SSZ-95 catalyst composition is used. For example, the base oil yield may be notably increased by at least about 0.5 wt. % or 1.0 wt. %, when the combination of the first and second SSZ-91 and SSZ-95 catalyst compositions is used, as compared with the use, in the same process, of only SSZ-91 or SSZ-95 catalyst compositions.

In practice, hydrodewaxing is used primarily for reducing the pour point and/or for reducing the cloud point of the base oil by removing wax from the base oil. Typically, dewaxing uses a catalytic process for processing the wax, with the dewaxer feed is generally upgraded prior to dewaxing to increase the viscosity index, to decrease the aromatic and heteroatom content, and to reduce the amount of low boiling components in the dewaxer feed. Some dewaxing catalysts accomplish the wax conversion reactions by cracking the waxy molecules to lower molecular weight molecules. Other dewaxing processes may convert the wax contained in the hydrocarbon feed to the process by wax isomerization, to produce isomerized molecules that have a lower pour point than the non-isomerized molecular counterparts. As used herein, isomerization encompasses a hydroisomerization process, for using hydrogen in the isomerization of the wax molecules under catalytic hydroisomerization conditions.

Suitable hydrodewaxing conditions generally depend on the feed used, the catalyst used, desired yield, and the desired properties of the base oil. Typical conditions include a temperature of from 500° F. to 775° F. (260° C. to 413° C.); a pressure of from 15 psig to 3000 psig (0.10 MPa to 20.68 MPa gauge); a LHSV of from 0.25 hr⁻¹ to 20 hr⁻¹; and a hydrogen to feed ratio of from 2000 SCF/bbl to 30,000 SCF/bbl (356 to 5340 m³ H₂/m³ feed). Generally, hydrogen will be separated from the product and recycled to the isomerization zone. Generally, dewaxing processes of the present invention are performed in the presence of hydrogen. Typically, the hydrogen to hydrocarbon ratio may be in a range from about 2000 to about 10,000 standard cubic feet H₂ per barrel hydrocarbon, and usually from about 2500 to about 5000 standard cubic feet H₂ per barrel hydrocarbon. The above conditions may apply to the hydrotreating conditions of the hydrotreating zone as well as to the hydroisomerization conditions of the first and second catalyst. Suitable dewaxing conditions and processes are described in, e.g., U.S. Pat. Nos. 5,135,638; 5,282,958; and 7,282,134.

While the catalyst system and process has been generally described in terms of the combination of the first and second catalyst compositions comprising SSZ-91 and SSZ-95 molecular sieves, it should be understood that additional catalysts, including layered catalysts and treatment steps may be present, e.g., including, hydrotreating catalyst(s)/steps, guard layers, and/or hydrofinishing catalyst(s)/steps.

### EXAMPLES

SSZ-91 was synthesized according to U.S. Pat. No. 10,618,816 and SSZ-95 was synthesized according to U.S. Pat. No. 10,272,422. The aluminas were provided as Catapal® aluminas and Pural® aluminas from Sasol or Versal® aluminas from UOP. The SSZ-91 molecular sieve had a silica to alumina ratio (SAR) of 120 or less.

### Example 1—Hydroisomerization Catalyst Preparation

Hydroisomerization catalyst A was prepared as follows: crystallite SSZ-91 was composited with Catapal® alumina to provide a mixture containing 65 wt. % SSZ-91 zeolite. The mixture was extruded, dried, and calcined, and the dried and calcined extrudate was impregnated with a solution containing platinum. The overall platinum loading was 0.6 wt. %.

### Example 2—Hydroisomerization Catalyst B Preparation

Hydroisomerization catalyst B was prepared as described for Catalyst A to provide a mixture containing 45 wt. % SSZ-95. The dried and calcined extrudate was impregnated with platinum to provide an overall platinum loading of 0.325 wt. %.

### Example 3—Hydroisomerization Performance for Catalysts A, B and Combined A and B Systems

Catalysts A and B were used to hydroisomerize a vacuum gas oil (VGO) hydrocrackate feedstock having the properties shown in Table 1.

TABLE 1

| VGO Feedstock Property | Value |
|---|---|
| gravity, °API | 31.1 |
| Sulfur content, wt. % | 23.4 |
| Nitrogen content, wt. % | 0.88 |
| Viscosity Index, VI | 117 |
| viscosity at 100° C. (cSt) | 10.21 |
| viscosity at 70° C. (cSt) | 23.32 |
| Pour Point, ° C. | 45 |
| SIM DIST Distillation Temperature (wt. %), °F. | |
| 0.5 | 723 |
| 5 | 804 |
| 10 | 827 |
| 30 | 876 |
| 50 | 913 |
| 70 | 960 |
| 90 | 1010 |
| 95 | 1027 |
| 99.5 | 1047 |

Hydroisomerization reactions were performed in a straight through micro unit fixed bed reactor (without recycle) and with only the feedstock and hydrogen fed to the reactor. The runs were operated under 2300 psig total pressure. Feedstock was passed through the reactor at a LHSV of 1 hr⁻¹. The hydrogen to oil ratio was about 4000 scfb and the reactor temperature range was 550-650° F. The base oil product was separated from fuels through a distillation section.

Runs were performed using only catalyst A, only catalyst B, a layered catalyst system with catalyst A on top of catalyst B in the same reactor (“A/B”), and a layered catalyst system with catalyst B on top of catalyst A in the same reactor (“B/A”). The layered A/B and B/A catalyst systems were conducted using 50 vol. % catalyst A and 50 vol. % catalyst B. The run for catalyst A alone was used as a “base case” to determine differential hydroisomerization catalyst temperatures. Catalyst hydroisomerization performance results are shown in Table 2.

TABLE 2

| | Catalyst | Catalyst | Catalyst | Catalyst | Catalyst | Catalyst | Catalyst |
|---|---|---|---|---|---|---|---|
| Catalyst system | A | B | A/B | A/B | A/B | A/B | B/A |
| 1st Hydroisomerization | Base | — | +10 | +20 | 0 | +30 | −3 |
| catalyst temperature, ° F. | | | | | | | |
| 2nd Hydroisomerization | — | +10 | +10 | +0 | +20 | −100 | −3 |
| catalyst temperature, ° F. | | | | | | | |
| Base oil yield, wt. % | 87.36 | 87.01 | 90.5 | 90.5 | 90.3 | 89.1 | 89.24 |
| Viscosity Index, VI | 107 | 109 | 110 | 109 | 109 | 109 | 109 |
| Pour point, ° C. | −16 | −15 | −14 | −16 | −18 | −14 | −13 |

Compared to catalyst A (SSZ-91) and to catalyst B (SSZ-95) alone, the layered A/B and B/A catalyst systems showed significantly higher base oil yield of 2 wt. % or greater. In addition, the viscosity index for the layered catalyst systems was about 1-2 points higher than for the single catalyst systems.

The foregoing description of one or more embodiments of the invention is primarily for illustrative purposes, it being recognized that variations might be used which would still incorporate the essence of the invention. Reference should be made to the following claims in determining the scope of the invention.

For the purposes of U.S. patent practice, and in other patent offices where permitted, all patents and publications cited in the foregoing description of the invention are incorporated herein by reference to the extent that any information contained therein is consistent with and/or supplements the foregoing disclosure.

What is claimed is:

1. A hydroisomerization catalyst system, useful to make dewaxed products including base oils, comprising
a first catalyst composition comprising an SSZ-91 molecular sieve; and
a second catalyst composition comprising an SSZ-95 molecular sieve;
wherein, the first catalyst and the second catalyst compositions are arranged such that a hydrocarbon feedstock may be sequentially contacted with either the first or the second catalyst composition to provide a first product followed by contacting the first product with the other catalyst composition to provide a second product.

2. The catalyst system of claim 1, wherein the first and second catalyst compositions are arranged such that the feedstock is fed to the first catalyst composition to form the first product.

3. The catalyst system of claim 1, wherein the first and second catalyst compositions are arranged such that the feedstock is fed to the second catalyst composition to form the first product.

4. The catalyst system of claim 1, wherein the molecular sieve of each of the first and second catalyst compositions is combined with a matrix material to form, respectively, a first and second base material, and wherein each of the first and second catalyst compositions further comprises at least one modifier selected from Groups 6 to 10 and Group 14, and optionally further comprising a Group 2 metal, of the Periodic Table.

5. The catalyst system of claim 1, wherein the SSZ-91 molecular sieve comprises ZSM-48 type zeolite material, the molecular sieve having:
at least 70% polytype 6 of the total ZSM-48-type material;
an EUO-type phase in an amount of between 0 and 3.5 percent by weight; and
polycrystalline aggregate morphology comprising crystallites having an average aspect ratio of between 1 and 8.

6. The catalyst system of claim 5, wherein the silicon oxide to aluminum oxide mole ratio of the SSZ-91 molecular sieve is in the range of 40 to 220 or 50 to 220 or 40 to 200, or 50 to 140.

7. The catalyst system of claim 5, wherein the SSZ-91 molecular sieve comprises one of more of:
at least 80%, or 90%, polytype 6 of the total ZSM-48-type material;
between 0.1 and 2 wt. % EU-1;
crystallites having an average aspect ratio of between 1 and 5, or between 1 and 3;
or a combination thereof.

8. The catalyst system of claim 1, wherein the SSZ-95 molecular sieve is an MTT framework molecular sieve having a mole ratio of 20 to 70 of silicon oxide to aluminum oxide, a total micropore volume of between 0.005 and 0.02 cc/g; and a H-D exchangeable acid site density of up to 50% relative to SSZ-32.

9. The catalyst system of claim 4, wherein the modifier content is 0.01-5.0 wt. % or 0.01-2.0 wt. %, or 0.1-2.0 wt. % (total catalyst weight basis).

10. The catalyst system of claim 4, wherein the catalyst comprises Pt, or a combination of Pt and Pd, as the modifier in an amount of 0.01-1.0 wt. %, or 0.3-0.8 wt. % Pt or the combination of Pt and Pd, optionally further comprising Mg.

11. The catalyst system of claim 4, wherein the matrix material for either or both of the first and second catalyst compositions is selected from alumina, silica, ceria, titania, tungsten oxide, zirconia, or a combination thereof.

12. The catalyst system of claim 11, wherein either or both of the first and second catalyst compositions comprises 0.01 to 5.0 wt. % of the modifier, 0 to 99 wt. % of the matrix material, and 0.1 to 99 wt. % of the molecular sieve.

13. The catalyst system of claim 1, wherein the second stage product is a base oil product, or is used to make a base oil product, having a viscosity index of at least about 109 and/or a pour point of no greater than about −10° C. or −13° C.

14. A process for producing a base oil product having an increased base oil product yield, the process comprising contacting a hydrocarbon feedstock with the hydroisomerization catalyst system of claim 1 under hydroisomerization conditions to produce a base oil product.

15. The process of claim 14, wherein the hydrocarbon feedstock comprises gas oil; vacuum gas oil; long residue; vacuum residue; atmospheric distillate; heavy fuel; oil; wax and paraffin; used oil; deasphalted residue or crude; charges resulting from thermal or catalytic conversion processes; shale oil; cycle oil; animal and vegetable derived fats, oils and waxes; petroleum and slack wax; or a combination thereof.

16. The process of claim 14, wherein the base oil yield is increased using the catalyst system of claim 1 as compared with the same process using only the first catalyst composition or the second catalyst composition.

17. The process of claim 16, wherein the base oil yield is increased by at least about 1 wt. % using the catalyst system of claim 1 as compared with the same process using only the first catalyst composition or the second catalyst composition.

18. The process of claim 14, wherein the first and second catalyst compositions are arranged such that the hydrocarbon feedstock is fed to the first catalyst composition to form the first product.

19. The process of claim 14, wherein the first and second catalyst compositions are arranged such that the hydrocarbon feedstock is fed to the second catalyst composition to form the first product.

20. The process of claim 14, wherein the second stage product is a base oil product, or is used to make a base oil product, having a viscosity index of at least about 109 and/or a pour point of no greater than about −13° C. or −10° C.
